(19) United States
(12) Patent Application Publication
(10) Pub. No.: US 2010/0176923 A1
(43) Pub. Date: Jul. 15, 2010

(54) WIRELESS TRANSMISSION APPARATUS AND METHOD

(75) Inventor: MING-YU TU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/508,588

(22) Filed: Jul. 24, 2009

(30) Foreign Application Priority Data
Jan. 14, 2009 (CN) 200910300181.9

(51) Int. Cl. H04Q 5/22

(52) U.S. Cl. 340/10.1

(57) ABSTRACT

A wireless transmission apparatus for transmitting electrical energy and a data stream between a base electronic device and a portable electronic device. The wireless transmission apparatus includes a mobile transceiver installed in the portable electronic device and a base transceiver installed in the base electronic device. Each of the mobile transceiver and the base transceiver includes a storage unit for storing data, an encoder unit for encoding a data stream into data and decoding data into a data stream, a power supply unit for supplying electrical energy, a convertor unit for converting a direct current into an alternating current and converting an alternating current into a direct current, a modem unit for modulating an alternating current in accordance with a data stream and demodulating an alternating current to a obtain data stream carried by the alternating current, and an induction unit for transmitting and receiving a modulated alternating current.

### BACKGROUND

1. Technical Field

The present disclosure relates to wireless transmission apparatuses and methods and, particularly, to a wireless transmission apparatus and method capable of transmitting electrical energy and data streams.

2. Description of Related Art

In general, portable electronic devices need to be recharged using a cable. In addition, some functions of certain portable electronic devices involve transmitting a data stream using a cable. The need for a cable detracts from the portability of the portable electronic device. Furthermore, the connectors for the cable connection are liable to become worn or damaged over time. If the connector of the portable electronic device is damaged, the service life of the portable electronic device may be shortened.

What is needed, therefore, is a wireless transmission apparatus and method thereof to overcome the above mentioned problems.

### BRIEF DESCRIPTION OF THE DRAWINGS

FIG. 1 is a block diagram of a wireless transmission apparatus according to an exemplary embodiment of the disclosure, the wireless transmission apparatus including a mobile transceiver and a base transceiver.

FIG. 2 is a schematic plan view of a base electronic device and a portable electronic device, showing the base transceiver and the mobile transceiver of FIG. 1 therein in phantom, respectively.

FIG. 3 is a flowchart of a wireless transmission method according to another exemplary embodiment of the disclosure.

FIG. 4 is a flowchart of more details of the wireless transmission method of FIG. 3 when transmission of electrical energy is performed.

FIG. 5 is a flowchart of more details of the wireless transmission method of FIG. 3 when transmission of a data stream is performed.

### DETAILED DESCRIPTION

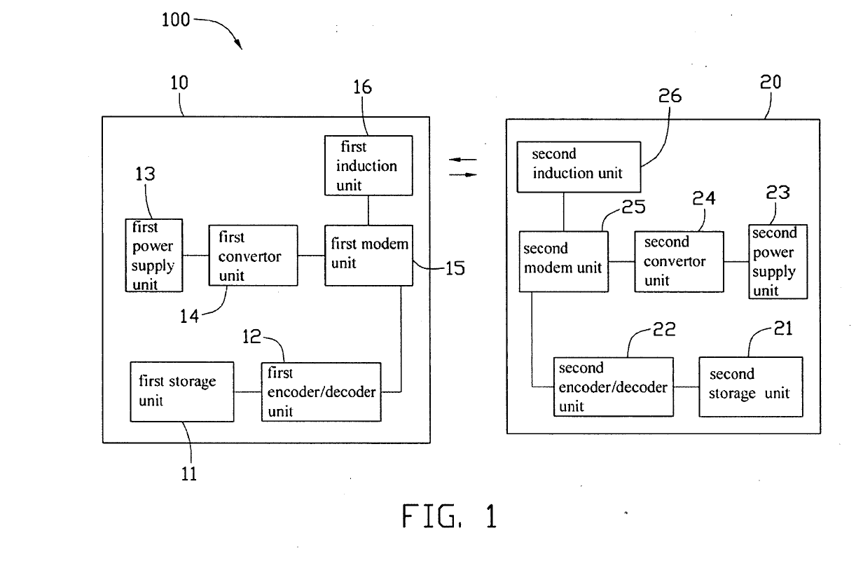

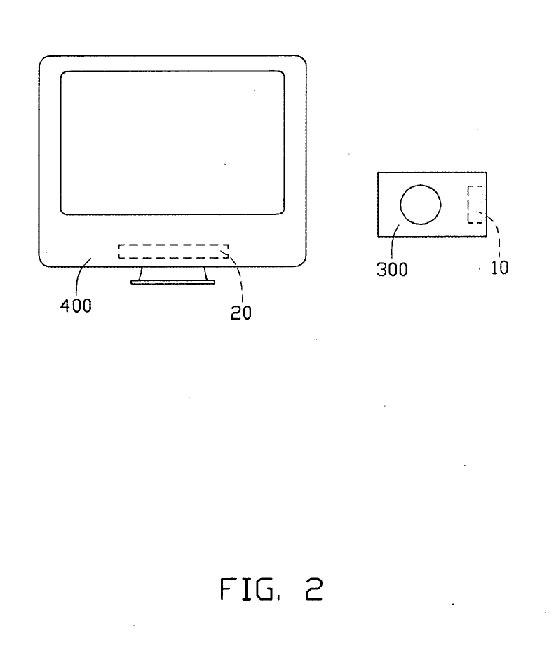

Referring to FIGS. 1-2, these show a wireless transmission apparatus 100 according to an exemplary embodiment. The wireless transmission apparatus 100 is for transmitting electrical energy and/or data streams between a base electronic device 400, such as a desktop computer, and a portable electronic device 300, such as a mobile phone or a digital camera. In this description, unless the context indicates otherwise, “electrical energy” includes electrical power. The wireless transmission apparatus 100 includes a mobile transceiver 10 installed in the portable electronic device 300, and a base transceiver 20 installed in the base electronic device 400.

The mobile transceiver 10 includes a first storage unit 11, a first encoder/decoder unit 12, a first power supply unit 13, a first convertor unit 14, a first modem unit 15, and a first induction unit 16.

The first storage unit 11 is configured (i.e. structured and arranged) for storing data of the portable electronic device 300, such as data of text, software programs, images, audio, video, or other data types.

The first encoder/decoder unit 12 is configured for encoding a data stream transmitted from the base electronic device 400 and through the first modem unit 15 into encoded data, and for decoding encoded data stored in the first storage unit 11 into a data stream.

The first power supply unit 13 is configured for supplying electrical energy to the mobile transceiver 10, and can for example be a battery.

The first convertor unit 14 is configured for converting a characteristic of electrical current flowing therein. For example, the first convertor unit 14 can transform a direct current (DC) from the first power supply unit 13 into an alternating current (AC), to allow modulation of the current. Thereupon, the AC is output to the first modem unit 15. Conversely, the first convertor unit 14 can convert AC from the modem unit 15 into DC, and output the DC to the first power supply unit 13 thereby charging the first power supply unit 13. That is, the first convertor unit 14 can include an AC/DC convertor and a DC/AC convertor.

The first modem unit 15 is configured for modulating the AC from the first convertor unit 14 in accordance with a data stream from the first encoder/decoder unit 12, thereby yielding a modulated AC. In detail, the first modem unit 15 can modulate the amplitude, frequency, and phase of the input AC. In addition, the first modem unit 15 can demodulate a modulated AC received from the first induction unit 16, thereby yielding a demodulated AC and a data stream. That is, the first modem unit 15 can demodulate an AC to obtain a data stream carried by the AC.

The first induction unit 16 is configured for transmitting a modulated AC to the base transceiver 20 and receiving a modulated AC transmitted from the base transceiver 20. In an exemplary application, the first induction unit 16 may include a number of induction coils by which the modulated AC is converted to electromagnetic waves and by which electromagnetic waves are converted to AC. That is, transmission to and receiving from the base transceiver 20 is accomplished using electromagnetic waves.

The base transceiver 20 includes a second storage unit 21, a second encoder/decoder unit 22, a second power supply unit 23, a second convertor unit 24, a second modem unit 25, and a second induction unit 26. The second storage unit 21, the second encoder/decoder unit 22, the second power supply unit 23, the second convertor unit 24, the second modem unit 25, and the second induction unit 26 generally have functions similar to the first encoder/decoder unit 12, the first power supply unit 13, the first convertor unit 14, the first modem unit 15, and the first induction unit 16 correspondingly.

Generally, the base electronic device 400 is powered by an external power source such as mains electricity from a power outlet. Thereby, electrical energy can be transmitted from the base electronic device 400 to the portable electronic device 300. The portable electronic device 300 captures information which is, in turn, to be transferred to the base electronic device 400. A data stream is, thus, transmitted from the portable electronic device 300 to the base electronic device 400.

To control signal loss, before transmission, the portable electronic device 300 is disposed in the vicinity of the base electronic device 400. Alternatively, the base electronic device 400 may further include an induction platform or dock (not shown), on or in which the portable electronic device 300 is docked. In particular, the portable electronic device 300 is disposed on or in the induction platform so that the first induction unit 16 faces the second induction unit 26. In such case, signal loss can be minimized, and highly efficient transmission can be achieved.

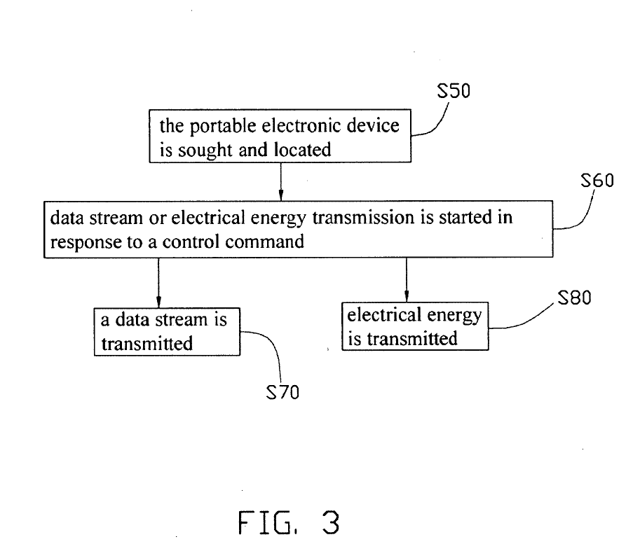

Referring to FIG. 3, this shows a wireless transmission method according to another exemplary embodiment. The wireless transmission method can be performed by a wireless transmission apparatus, such as, for example, the wireless transmission apparatus 100. The wireless transmission method includes steps as follows:

In step 50, the portable electronic device 300 is sought and located. In particular, the second induction unit 26 of the base transceiver 20 continuously emits a radio signal to a desired vicinity of the base electronic device 400, such as the induction platform thereof. If and when the portable electronic device 300 is in the vicinity of the base electronic device 400, the first induction unit 16 of the mobile transceiver 10 responds with induction of a corresponding radio signal, which is transmitted to the base transceiver 20 and received by the second induction unit 26. A wireless connection between the base electronic device 400 and the portable electronic device 300 is thereby established. That is, the portable electronic device 300 is successfully located. It should be noted that, further or alternatively, the portable electronic device 300 can emit a radio signal to seek and locate the base electronic device 400.

In step 60, data stream transmission, electrical energy transmission, or both data stream transmission and electrical energy transmission, is started in response to a control command. The control command may be input via a keypad, touch screen or other means of the portable electronic device 300, or via a keyboard, keypad, mouse or other means of the base electronic device 400.

In step 70, a data stream is transmitted.

In step 80, electrical energy is transmitted.

In detail, in step 60, if it is determined that the transmission is to be data stream transmission, step 70 is executed. If it is determined that the transmission is to be electrical energy transmission, step 80 is executed. Further, if it is determined that the transmission is to be both data stream transmission and electrical energy transmission, steps 70 and 80 are performed at the same time.

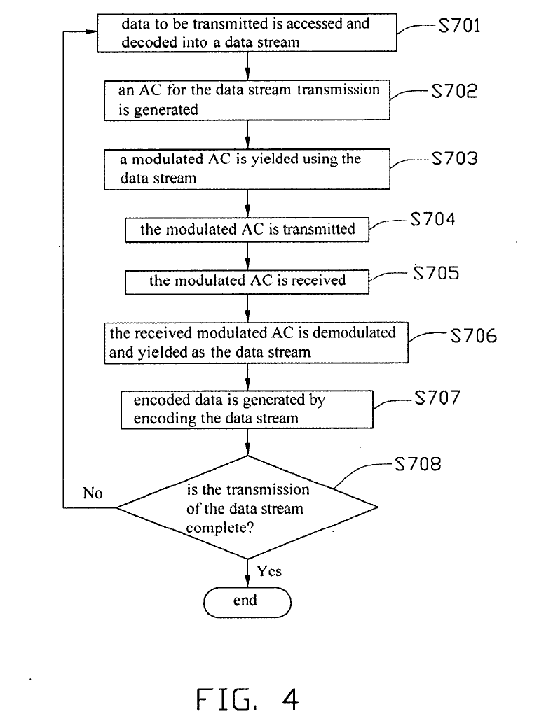

Referring to FIG. 4, step 70 includes:

In step 701, data to be transmitted is accessed and decoded into a data stream. This step can be performed by the first encoder/decoder unit 12.

In step 702, an AC for the data stream transmission is generated. This step can be performed by the first power supply unit 13 and the first convertor unit 14.

In step 703, a modulated AC is yielded using the data stream. This step can be performed by the first modem unit 15.

In step 704, the modulated AC is transmitted. This step can be performed by the first induction unit 16.

In step 705, the modulated AC is received. This step can be performed by the second induction unit 26.

In step 706, the received modulated AC is demodulated to thereby yield the data stream. This step can be performed by the second modem unit 25.

In step 707, encoded data is generated by encoding the data stream. This step can be performed by the second encoder/decoder unit 22. The encoded data can be stored in the second storage unit 21 of the base electronic device 400 or displayed on a screen of the base electronic device 400.

In step 708, in response to a control command, it is determined whether the transmission of the data stream is complete. The control command may be automatically preset in advance (e.g., according to a predetermined timeout), or may be generated manually by a user. If so, the method of step S70 is completed. If not, the procedure goes back to step 701.

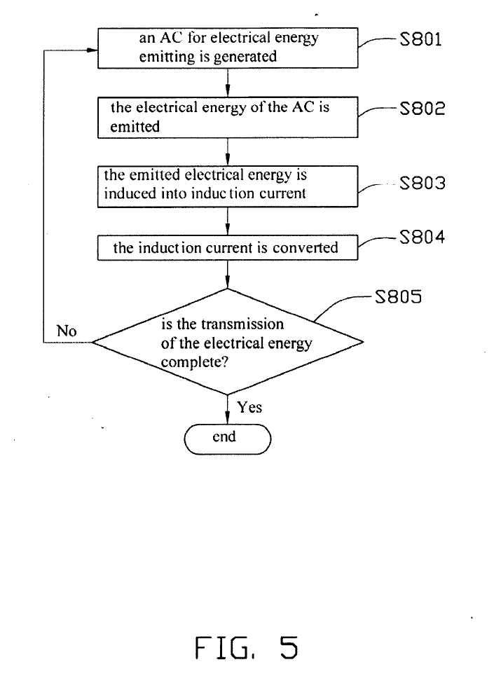

Referring to FIG. 5, step 80 includes the following:

In step 801, an AC for electrical energy transmission is generated. This step can be performed by the second power supply unit 23 and the second convertor unit 24.

In step 802, the electrical energy of the AC is emitted in the form of electromagnetic waves. This step can be performed by the second induction unit 26.

In step 803, the emitted electrical energy is induced into an induction current. The induction current is an AC. This step can be performed by the first induction unit 16.

In step 804, the AC induction current is converted to a DC current. The DC current can be used to power the portable electronic device 300 in real time, or can be used to recharge a battery of the portable electronic device 300.

In step 805, in response to a control command, it is determined whether the transmission of the electrical energy is complete. If so, the method of step S80 is completed. If not, the procedure goes back to step 801.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A wireless transmission apparatus for transmitting at least one of electrical energy and a data stream between a base electronic device and a portable electronic device, the wireless transmission apparatus comprising:
a mobile transceiver installed in the portable electronic device; and
a base transceiver installed in the base electronic device, each of the mobile transceiver and the base transceiver comprising:
a storage unit configured for storing data;
an encoder unit configured for encoding a data stream into data and decoding data stored in the storage unit into a data stream;
a power supply unit configured for supplying electrical energy;
a convertor unit configured for converting a direct current into an alternating current and converting an alternating current into a direct current;
a modem unit configured for modulating an alternating current in accordance with a data stream and demodulating an alternating current to obtain a data stream carried by the alternating current; and
an induction unit configured for transmitting and receiving a modulated alternating current.

2. The wireless transmission apparatus of claim 1, wherein the portable electronic device is a digital camera, and the base electronic device is a desktop computer.

3. The wireless transmission apparatus of claim 1, wherein the data is selected from the group consisting of data of text, software programs, images, audio, and video.

4. The wireless transmission apparatus of claim 1, wherein the modem unit is configured for modulating the converted alternating current generated by the convertor unit in accordance with a data stream, and the power supply unit is further configured for receiving and storing the converted direct current generated by the convertor unit.

5. The wireless transmission apparatus of claim 4, wherein the modem unit is configured for modulating at least one characteristic of the alternating current selected from the group consisting of the amplitude of the alternating current, the frequency of the alternating current, and the phase of the alternating current.

6. The wireless transmission apparatus of claim 1, wherein the induction unit comprises a plurality of induction coils, the induction coils are capable of converting the modulated alternating current to electromagnetic waves and capable of converting electromagnetic waves to an alternating current, such that transmission of at least one of electrical energy and a data stream between the mobile transceiver and the base transceiver is accomplished using the electromagnetic waves.

7. A wireless transmission method executed by a wireless transmission apparatus, the wireless transmission method comprising:
seeking and locating at least one of a portable electronic device and a base electronic device;
starting data stream transmission, electrical energy transmission, or both data stream transmission and electrical energy transmission, in response to a control command; and
transmitting a data stream, electrical energy, or both a data stream and electrical energy simultaneously.

8. The wireless transmission method of claim 7, wherein the control command is input via a keypad or touch screen of the portable electronic device or via a keyboard, keypad or mouse of the base electronic device.

9. The wireless transmission method of claim 7, wherein starting data stream transmission and transmitting the data stream further comprise:
accessing data to be transmitted and decoding the data into a data stream;
generating an alternating current for data stream transmission;
modulating the alternating current using the data stream to yield a modulated alternating current;
transmitting the modulated alternating current;
receiving the modulated alternating current;
demodulating the received modulated alternating current into a data stream;
encoding the data stream into encoded data; and
determining whether the transmission of the data stream is complete, and, if so, ending the data stream transmission, or, if not, continuing accessing data to be transmitted and decoding the data into a data stream.

10. The wireless transmission method of claim 7, wherein starting electrical energy transmission and transmitting the electrical energy further comprise:
generating an alternating current for electrical energy transmission;
emitting the electrical energy of the alternating current in the form of electromagnetic waves;
inducing the emitted electrical energy into an alternating current induction current;
converting the alternating current induction current into a direct current; and
determining whether the transmission of the electrical energy is complete, and, if so, ending the electrical energy transmission, or, if not, continuing generating an alternating current for electrical energy transmission again.

11. The wireless transmission method of claim 10, further comprising applying the direct current to power the portable electronic device or recharge a battery of the portable electronic device.
